(19) United States
(12) Patent Application Publication
(10) Pub. No.: US 2019/0381720 A1
(43) Pub. Date: Dec. 19, 2019

(54) Plasma Treatment for Bottle Seals

(71) Applicant: Niagara Bottling, LLC, Ontario, CA (US)

(72) Inventors: Jay Clarke Hanan, Ontario, CA (US); Alexander Telemachos Mouschovias, Ontario, CA (US)

(73) Assignee: Niagara Bottling, LLC, Ontario, CA (US)

(21) Appl. No.: 16/444,500

(22) Filed: Jun. 18, 2019

Related U.S. Application Data
(60) Provisional application No. 62/687,178, filed on Jun. 19, 2018.

(51) Int. Cl. B29C 59/14; B65D 1/02; H05H 1/34

(52) U.S. Cl. CPC B29C 59/142; B29L 2031/7158; H05H 1/34; B65D 1/0207

(57) ABSTRACT

Disclosed herein are embodiments of a plasma treatment system and methods for utilizing directed plasma to reduce instances of gas venting and leaking of contents from plastic bottles due to scratches occurring on sealing interfaces of the bottles and closures. In an embodiment, a plasma treatment system for repairing scratches applied to PET bottles comprises one or more plasma nozzles disposed along a bottle filling line and a plasma being issued by the plasma nozzles to repair the scratches. The plasma nozzles are arranged into a configuration that uniformly distributes plasma to all parts of a neck finish comprising the PET bottles. The plasma treatment of the PET bottles is performed prior to capping of the bottles. In an embodiment, the plasma treatment is performed after filling the bottles with contents so as to avoid a risk of scratches from misaligned filling tubes.

### PRIORITY

This application claims the benefit of and priority to U.S. Provisional Application, entitled “Plasma Treatment For Bottle Seals,” filed Jun. 19, 2018 and having application Ser. No. 62/687,178, the entirety of said application being incorporated herein by reference.

### FIELD

Embodiments of the present disclosure generally relate to plastic bottles and preforms. More specifically, embodiments of the disclosure relate to systems and methods for utilizing directed plasma to reduce instances of gas venting and/or leaking of contents from bottles due to scratches occurring on sealing interfaces of the bottles and closures.

### BACKGROUND

Plastic containers have been used as a replacement for glass or metal containers in the packaging of beverages for several decades. The most common plastic used in making beverage containers today is polyethylene terephthalate (PET). Containers made of PET are transparent, thin walled, and have the ability to maintain their shape by withstanding the force exerted on the walls of the container by their contents. PET resins are also reasonably priced and easy to process. PET bottles are generally made by a process that includes the blow-molding of plastic preforms which have been made by injection molding of the PET resin.

Advantages of plastic packaging include lighter weight and decreased breakage as compared to glass, and lower costs overall when taking both production and transportation into account. Although plastic packaging is lighter in weight than glass, there is still great interest in creating the lightest possible plastic packaging so as to maximize the cost savings in both transportation and manufacturing by making and using containers that contain less plastic.

Disclosed herein are an apparatus and methods for utilizing directed plasma to reduce instances of gas venting and/or leaking of contents from bottles due to scratches occurring on sealing interfaces of the bottles.

### SUMMARY

A plasma treatment system and a method are provided for utilizing directed plasma to reduce instances of gas venting and leaking of contents from plastic bottles due to scratches occurring on sealing interfaces of the bottles and closures. In an embodiment, a plasma treatment system for repairing scratches applied to polyethylene terephthalate (PET) bottles comprises one or more plasma nozzles disposed along a bottle filling line and a plasma being issued by the one or more plasma nozzles to repair the scratches. The one or more plasma nozzles are arranged into a configuration that uniformly distributes plasma to all parts of a neck finish comprising the PET bottles. The plasma treatment of the PET bottles is performed prior to applying closures to the bottles. In an embodiment, the plasma treatment is performed after filling the bottles with contents so as to avoid potential scratches due to misaligned filling tubes.

In an exemplary embodiment, a plasma treatment system for repairing scratches applied to PET bottles, preforms and closures comprises: one or more plasma nozzles disposed along a bottle filling line; a plasma being issued by way of the one or more plasma nozzles, the plasma being suitable for repairing scratches in PET bottles; and a multiplicity of PET bottles being processed by way of the bottle filling line.

In another exemplary embodiment, the one or more plasma nozzles include any of single nozzles, one or more stationary nozzles, and rotary nozzles. In another exemplary embodiment, the one or more plasma nozzles are positioned between 1 mm and 10 mm above the PET bottles. In another exemplary embodiment, the one or more plasma nozzles are positioned between 4 mm and 7 mm above the PET bottles.

In another exemplary embodiment, the one or more plasma nozzles are positioned to treat the inside of a neck finish comprising each of the multiplicity of PET bottles where a plug seal comprising the closure establishes a seal. In another exemplary embodiment, the one or more plasma nozzles are custom designed for each application. In another exemplary embodiment, the outside and top of each of the multiplicity of PET bottles are plasma treated due to the motion of the multiplicity of PET bottles along the bottle filling line and relative to the one or more plasma nozzles.

In another exemplary embodiment, the one or more plasma nozzles are configured to treat the multiplicity of PET bottles before closures are coupled with the multiplicity of PET bottles. In another exemplary embodiment, the multiplicity of PET bottles are treated after all machine handling has finished at one or more sealing locations. In another exemplary embodiment, plasma treatment of the multiplicity of PET bottles is performed in a bottle labeler, after blowing the multiplicity of PET bottles and before filling the multiplicity of PET bottles. In another exemplary embodiment, plasma treatment of the multiplicity of PET bottles is performed after filling the multiplicity of PET bottles so as to avoid potential scratches to any of the multiplicity of PET bottles due to misaligned filling tubes.

In another exemplary embodiment, the one or more plasma nozzles includes a number of plasma nozzles arranged into a configuration that distributes plasma to all parts of a neck finish comprising each of the multiplicity of PET bottles. In another exemplary embodiment, the one or more plasma nozzles includes between 4 plasma nozzles and 16 plasma nozzles that are arranged into a staggered configuration, a straight configuration, or a combination thereof. In another exemplary embodiment, the one or more plasma nozzles includes 8 plasma nozzles arranged in a staggered configuration to distribute plasma to all parts of a neck finish comprising each of the multiplicity of PET bottles. In another exemplary embodiment, the one or more plasma nozzles includes 8 plasma nozzles arranged in a straight configuration, such that the plasma nozzles point at opposite sides of a neck finish comprising each of the multiplicity of PET bottles.

In an exemplary embodiment, a method for a plasma treatment system for repairing scratches applied to PET bottles, preforms and closures comprises: disposing one or more plasma nozzles along a bottle filling line; configuring the one or more plasma nozzles to discharge a plasma suitable for repairing scratches in PET bottles; and subjecting a multiplicity of PET bottles to the plasma during processing by way of the bottle filling line.

In another exemplary embodiment, disposing includes positioning the one or more plasma nozzles to treat the inside of a neck finish comprising each of the multiplicity of PET bottles, wherein the inside of the neck finish comprises a location where a plug seal of a bottle closure establishes a seal. In another exemplary embodiment, disposing includes positioning the one or more plasma nozzles in a bottle labeler comprising the bottle filling line. In another exemplary embodiment, disposing includes positioning the one or more plasma nozzles at a location of the bottle filling line after filling of the multiplicity of PET bottles so as to avoid potential scratches to any of the multiplicity of PET bottles due to misaligned filling tubes. In another exemplary embodiment, disposing includes arranging the one or more plasma nozzles into a configuration that uniformly distributes plasma to all parts of a neck finish comprising each of the multiplicity of PET bottles.

In an exemplary embodiment, a plasma treatment system for repairing defects in polymer closures comprises: one or more plasma nozzles disposed along a bottle filling line; a multiplicity of polymer closures being processed by way of a conveyor or a rail of the bottle filling line; and a plasma being issued by way of the one or more plasma nozzles, the plasma being suitable for repairing defects in the multiplicity of polymer closures. In another exemplary embodiment, the defects include gas marks and scratches disposed in any of the multiplicity of polymer closures.

### BRIEF DESCRIPTION OF THE DRAWINGS

The drawings refer to embodiments of the present disclosure in which:

FIG. 1 illustrates an exemplary embodiment of a plasma treatment being applied to a PET bottle preform, according to the present disclosure;

FIG. 2 illustrates a PET bottle preform including a multiplicity of scratches before and after being subjected to plasma treatment;

FIG. 3 illustrates a PET bottle preform that includes a single deep scratch that is suitable for plasma treatment in accordance with the present disclosure;

FIG. 4 illustrates an exemplary embodiment of a plasma nozzle that translates above a PET bottle preform;

FIG. 5 illustrates a cross-sectional view of a conical tip indenter for forming progressive scratches on the surface of PET disks;

FIG. 6 illustrates scratch data pertaining to multiple scratches applied to a PET disk before receiving a plasma treatment;

FIG. 7 illustrates a 3-dimensional view of the scratch data of FIG. 6;

FIG. 8 illustrates scratch data pertaining to the multiple scratches of FIG. 6 after application of the plasma treatment to the PET disk;

FIG. 9 is a graph illustrating scratch data obtained by way of a high resolution profilometer that uses line scans;

FIG. 10 illustrates surface data after a plasma treatment has been applied to a surface;

FIG. 11 illustrates an exemplary embodiment of a plasma nozzle that may be used for plasma treatment, according to the present disclosure;

FIG. 12 illustrates an exemplary embodiment of a conveyor system transporting a multiplicity of PET bottles to a bottle labeler;

FIG. 13 illustrates an isometric view of an exemplary embodiment of a plasma treatment apparatus for reducing scratches on PET bottles;

FIG. 14 illustrates eight plasma nozzles comprising the plasma treatment apparatus of FIG. 13 arranged in a staggered configuration so as to distribute a plasma treatment to all parts of a neck finish comprising PET bottles;

FIG. 15 illustrates the eight plasma nozzles of FIG. 14 disposed above a conveyor system for transporting a multiplicity of PET bottles to a bottle labeler;

FIG. 16 illustrates an exemplary embodiment of a plasma treatment apparatus disposed within a bottle labeler;

FIG. 17 illustrates a plasma treatment being applied to a multiplicity of PET bottles during being conveyed toward a bottle labeler;

FIG. 18 illustrates graphs of baseline venting as a percentage of full pallet vented occurring over time expressed in hours;

FIG. 19 illustrates graphs of percentage of full pallet vented at T=0 hours after receiving a plasma treatment;

FIG. 20 illustrates graphs of percentages of full pallet vented at T=24 hours after receiving a plasma treatment;

FIG. 21 illustrates graphs of percentages of full pallet vented at T=168 hours after receiving a plasma treatment;

FIG. 22 illustrates graphs of percentages of full pallet vented at T=336 hours after receiving a plasma treatment;

FIG. 23 illustrates graphs of percentages of full pallet vented at T=672 hours after receiving a plasma treatment;

FIG. 24 illustrates a surface scan showing a surface roughening observed on a polymer after a plasma treatment; and

FIG. 25 is a graph illustrating surface heights detected along a line scan performed along a polymer surface.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first bottle seal,” may be made. However, the specific numeric reference should not be interpreted as a literal sequential order but rather interpreted that the “first bottle seal” is different than a “second bottle seal.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Many manufacturers of non-carbonated beverages, such as water, juices, teas, and the like, generally rely upon bottles formed of polyethylene terephthalate (PET). Over the years, environmental and cost pressures have led to a use of thinner-walled PET bottles, thereby reducing the weight of PET polymers in the bottles, resulting in structurally weaker bottles. After filling, however, bottles must be stacked so they can be transported to customers. As will be appreciated, weak bottles at the bottom of a pallet may buckle under the weight of the bottles above, creating unsafe conditions and costly product losses. Causes of weak bottles include venting gas and/or leaking of contents from the bottles due to scratches occurring on one or more of the bottle cap and the sealing interface of the bottle. Disclosed herein are embodiments of an apparatus and methods for utilizing directed plasma to smooth surfaces and improve seal performance of the bottles.

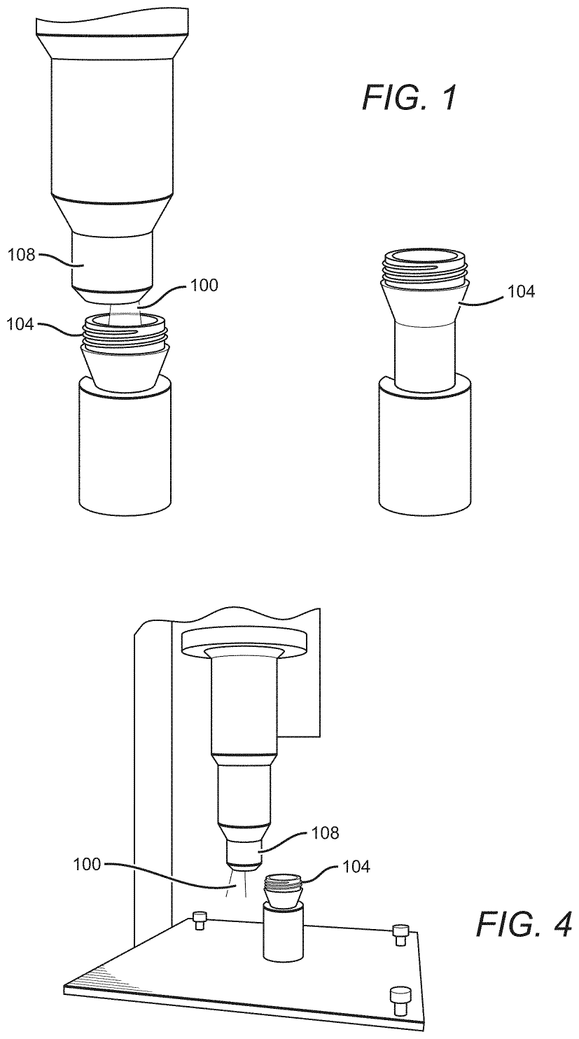

FIG. 1 illustrates an exemplary embodiment of a plasma treatment 100 being applied to a PET bottle preform 104, according to the present disclosure. In the illustrated embodiment, a plasma nozzle 108 translates above the PET bottle preform 104 at a speed of about 75 millimeters per second (mm/s). Atmospheric plasma is known to be useful for treating, etching and altering the surface energy (activation) of plastics, such as PET as used in plastic bottles. Surface scratches are comprised of high energy domains that may be modified by way of plasma treatment according to the present disclosure. In the illustrated embodiment of FIG. 1, either air or nitrogen (N₂) may be used to generate the plasma treatment 100, without limitation.

In one embodiment, a plasma generator comprising a Plasmatreat FG5001 is used with a JR2500N desktop robot with a two-axis motion. In some embodiments, plasma nozzles 108 include single nozzles (e.g., PFW 10), multiple stationary nozzles, and rotary nozzles (e.g., RD1004). In general, the closer the plasma nozzles 108 are positioned to the PET bottle preform 104 or a neck finish thereof being treated, the fewer plasma nozzles 108 are needed. As will be appreciated, the plasma nozzles 108 should never touch the PET bottle preform 104 or neck finish being treated, and thus some clearance is necessary due to machine tolerances, vibration and safety. In some embodiments, the plasma nozzles 108 may be positioned between 1 mm and 10 mm above the PET bottle preforms 104 or neck finishes to be treated. In some embodiments, the plasma nozzles 108 are positioned between 4 mm and 7 mm above the PET bottle preforms 104 or neck finishes to be treated. Further, the plasma nozzle 108 may translate across the PET bottle preform 104 with a speed ranging between about 10 mm/s and 75 mm/s. In one embodiment, testing of applying plasma treatment to preforms included treating 5 preforms with plasma. It is contemplated that, in some embodiments, the plasma nozzles 108 can also be configured to travel into each neck finish or a bottle closure along a production line so as to reduce the number of plasma nozzles 108 needed to treat the neck finishes or bottle closures.

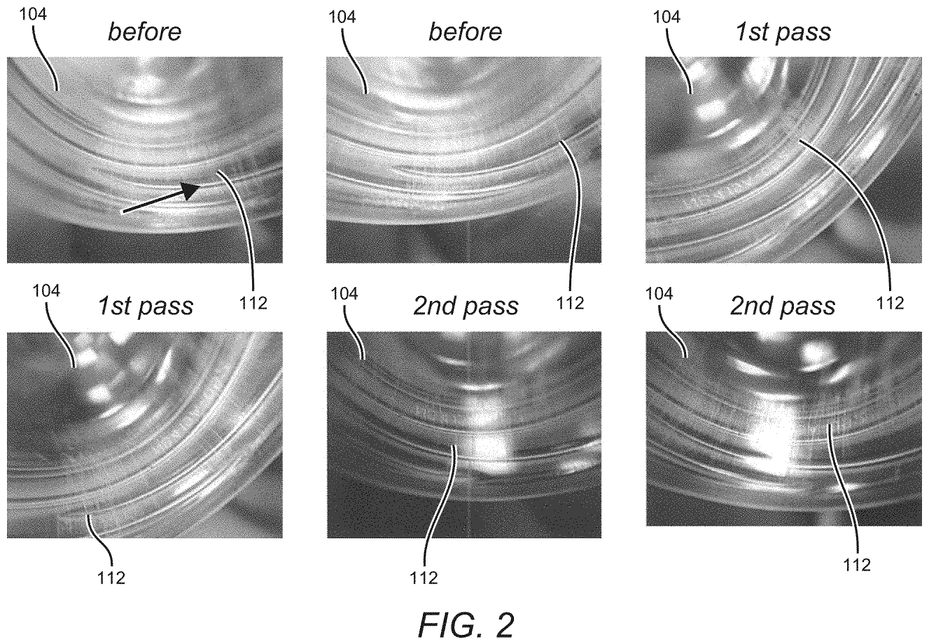

FIG. 2 illustrates a PET bottle preform 104 including a multiplicity of scratches 112 before and after being subjected to plasma treatment 100. In the illustrated embodiment, the PET bottle preform 104 comprises a 7.6-gram (g) PET preform that was scratched by way of 30 μm sandpaper. After being scratched, the PET bottle preform 104 was pressurized to 10 PSI and was found to lose pressure at about 2 PSI per minute. Plasma treatment 100 was applied to the PET bottle preform 104 with 6 total passes-3 parallel to the scratches 112 and 3 perpendicular to the scratches 112. The plasma treatment 100 effectively reduced the severity of the scratches 112 as shown in FIG. 2. After the plasma treatment 100, the PET bottle preform 104 was found to hold pressure for more than 4 days.

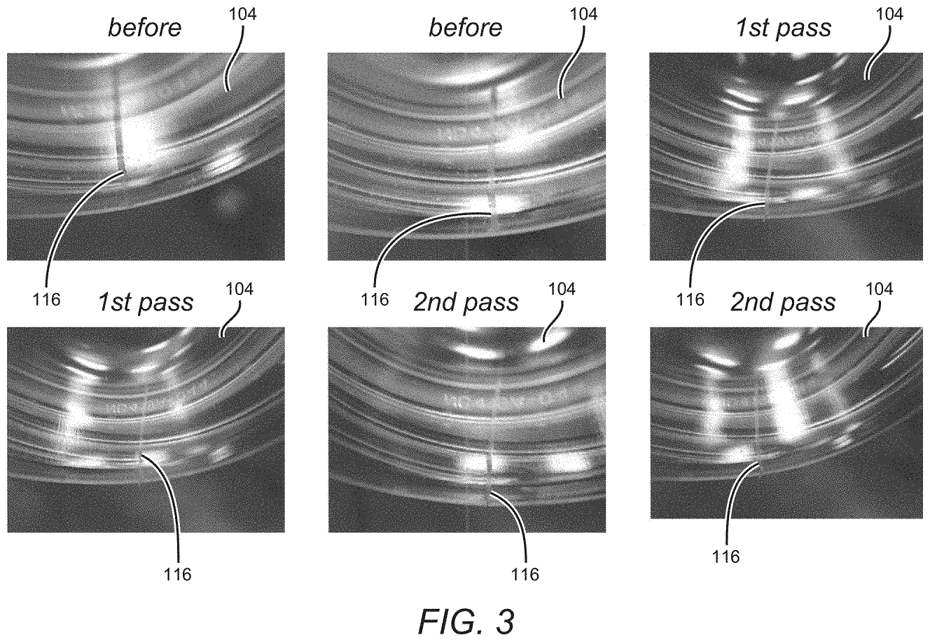

FIG. 3 illustrates a PET bottle preform 104 that includes a single deep scratch 116 that is suitable for plasma treatment 100. In the illustrated embodiment, the PET bottle preform 104 comprises a 7.6-g PET preform that was scratched by way of a screwdriver. The scratched PET bottle preform 104 was found to lose pressure at a rate of about 4 PSI per min when pressurized to an initial 10 PSI. The PET bottle preform 104 was treated with plasma treatment 100 at a 30 mm/s plasma nozzle 108 speed. As shown in FIG. 3, although the plasma treatment 100 reduced the severity of the scratch 116, the PET bottle preform 104 was not able to hold 10 PSI for very long, even after the plasma treatment 100.

As mentioned hereinabove, the plasma nozzle 108 preferably translates above the PET bottle preform 104, from side to side as shown in FIG. 4, so as to avoid potential damage due to overexposure of the plasma treatment 100. It has been observed that changing the speed with which plasma nozzles 108 pass over a PET bottle preform 104 being treated affects the duration of plasma treatment 100. For example, it was observed that applying the plasma treatment 100 at a translation speed of 20 mm/s caused softening of the preform. A translation speed of 25 mm/s, however, was found to be a lower limit to avoid damaging the finish of the PET bottle preforms 104.

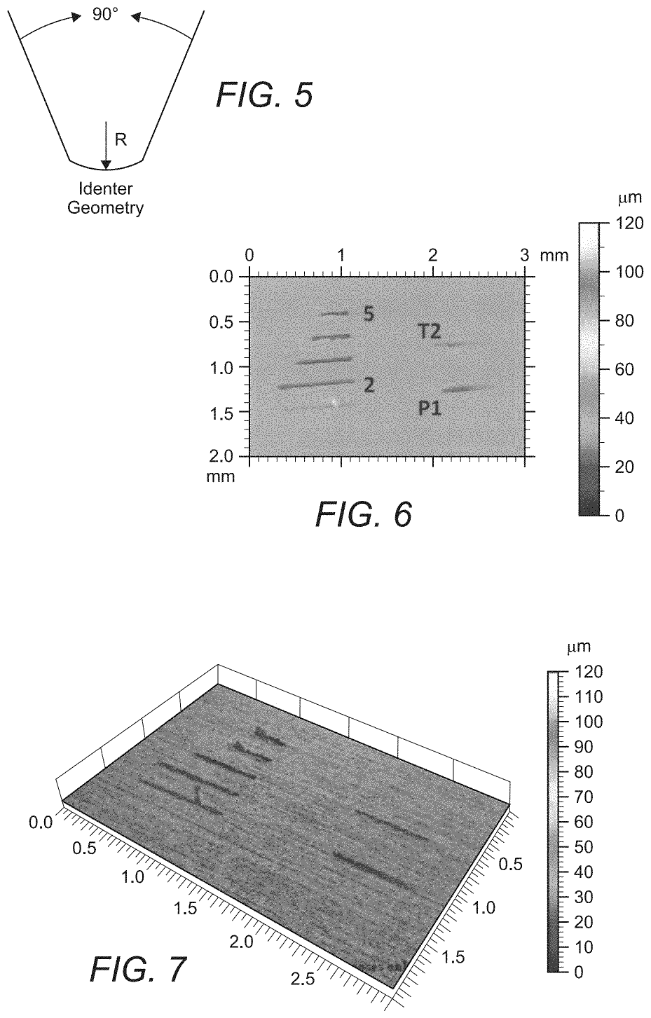

In addition to testing the plasma treatment 100, as described above, in some embodiments, testing was performed on PET disks having a diameter of about 25 mm and a thickness of about 1.5 mm. A conical tip indenter of 100 μm radius was used to form a progressive micro-scratch in the PET disks. FIG. 5 illustrates a cross-sectional view of the conical tip indenter that was used to form progressive scratches with a 300 mN critical force limit. The scratches applied to the PET disks to be subjected to the plasma treatment 100 had lengths ranging between about 0.8 mm and 1.0 mm, and were performed at a scratch speed of about 1.0 mm/s. Progressive scratches were performed with forces ranging between 10 mN and 250 mN. It was observed that a 40 mN scratch was slightly visible by way of a high resolution profilometer.

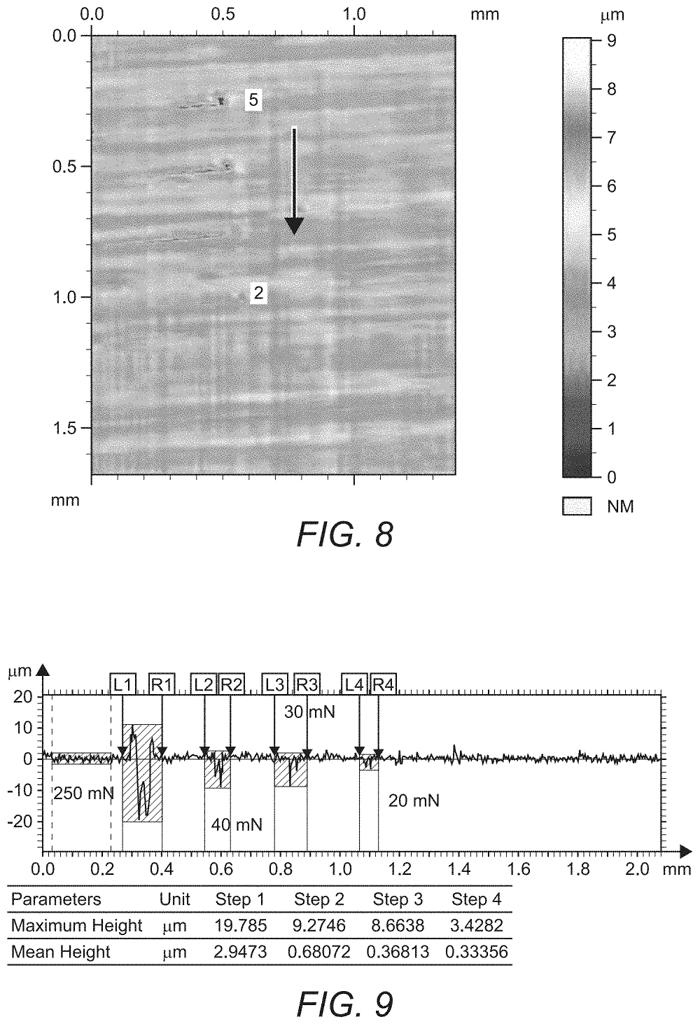

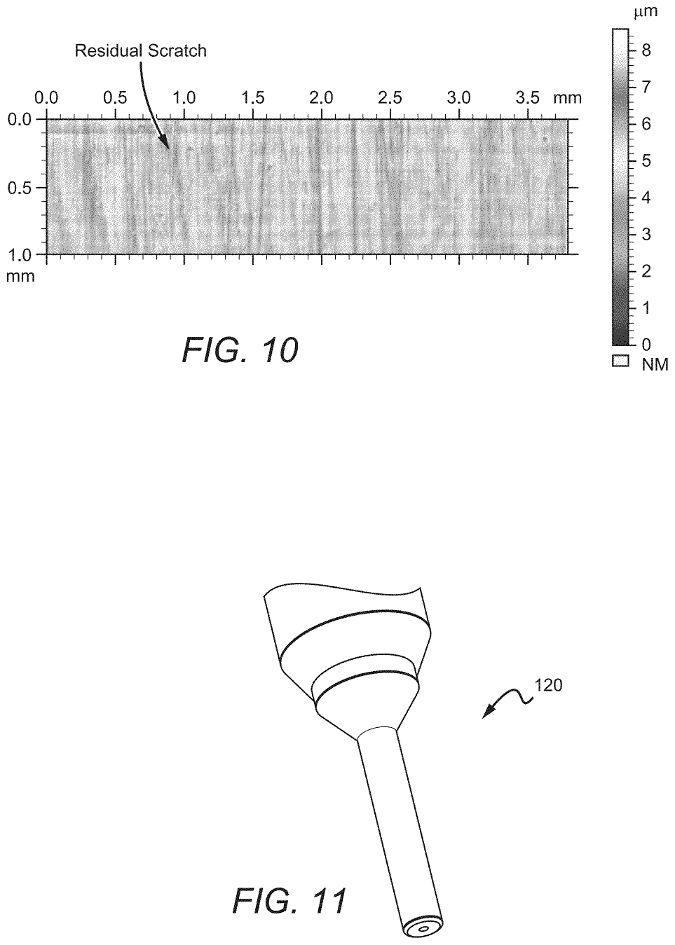

As shown in FIGS. 6-10, the high resolution profilometer was used to determine the depths of scratches before and after the plasma treatment 100 was applied to the PET disks. As indicated in FIGS. 6-7, before the plasma treatment 100, scratches 2-5 had respective depths of 14 μm, 10.6 μm, 15.5 μm, 18.3 μm. As indicated in FIG. 7, after the plasma treatment 100, scratches 2-5 had respective residual depths of 3.3 μm, 3.2 μm, 2.6 μm, 4.2 μm. FIGS. 9-10 illustrate scratch data obtained by way of a relatively higher resolution profilometer that utilizes line scans. As indicated in FIG. 9, scratches 2-5 had respective depths of 19.785 μm, 9.2746 μm, 8.6638 μm, and 3.4282 μm before the plasma treatment 100. As shown in FIG. 10, after the plasma treatment 100, scratch 5 has a residual depth of 4.7 μm. As such, a scratch recovery of up to 15 μm was observed. Further, at a distance of 10 mm between the plasma nozzle 108 and the scratches being treated, it was found that a plasma temperature of 300° C. can be used. It was determined that exhaust surrounding nozzle jets may be needed in the long-term to prevent corrosion from oxidizing agents.

FIG. 11 illustrates an exemplary embodiment of a plasma nozzle 120 that may be used for plasma treatment 100 according to the present disclosure. It is contemplated that, in some embodiments, plasma nozzles 120 can be custom designed for each application. For example, in some embodiments, plasma nozzles 120 may be single point nozzles with 45-degree bend. It is contemplated that the plasma nozzles 120 may be implemented with any of various configurations suitable for targeted application of the plasma treatment 100 to the PET bottle preform 104, without limitation. For example, the plasma nozzle 120 may be used to apply the plasma treatment 100 to an interior sealing surface of the PET bottle preform 104 where a plug seal of a closure engages with the sealing surface of the preform.

It is an objective of the present disclosure to plasma treat PET bottles as they move along a production line, after the bottles have been blown and before the bottles have been coupled with bottle closures (i.e., “capped”). As such, in some embodiments, stationary plasma jets are used to treat a multiplicity of bottles as they are moved along the production line, such as a bottle filling line. In some embodiments, plasma is used to treat the inside of a neck finish of each bottle where a plug seal of the bottle closures (i.e., a bottle cap) creates a seal. It is contemplated that since the bottles are moving past stationary plasma jets, the outside and top of the bottles are also plasma treated, in addition to plasma treating the interior of the neck finish. In some instances, treating the top and outside of the bottles may give secondary seal improvements on the TSS and/or outer guide interfaces.

In some embodiments, one or more plasma jets are configured to translate along a longitudinal axis of each bottle so as to insert into an interior of the bottle finish and direct a majority of the plasma jet energy to the interior sealing surface of the bottle. It is contemplated that treatment would be in a lateral direction on rotating or stationary heads of the plasma jets. It has been observed that such embodiments substantially prevent unwanted spray of plasma onto exterior portions of the bottle finish and nearby handling parts, and thus decrease erosion or other undesirable effects arising due to plasma overspray.

In some embodiments, plasma jets are configured to travel with the bottles along a wheel or conveyor to provide a constant spray of plasma for an extended time. It has been observed that, depending on the energy level provided, durations of plasma spray ranging between 0.2 seconds and 1 second are sufficient to remove typical scratches. As will be appreciated, effectiveness depends on the jet design, the distance of the jet from the surface being treated, and the desired depth of the scratch to be removed.

In some embodiments, exposure of the bottle finish to the plasma jet may be adjustable by way of a shield to shutter the spray. The shield may be configured to pass in front of the plasma jet when parts that are to remain untreated are passing underneath the shield, thereby preventing the plasma spray from contacting the parts.

It is contemplated that plasma treatment of blown PET bottles preferably occurs before capping, but after all machine handling has finished at the sealing locations. In some embodiments, plasma treatment of the bottles is performed in the labeler, after blowing of the bottles and before filling the bottles with contents. In some embodiments, the bottles may be plasma treated after filling the bottles with contents, thereby avoiding a risk of potential scratches due to misaligned filling tubes. As will be appreciated, some bottle filling lines fill the bottles before labeling, and thus in such embodiments, plasma treatment may be performed after blowing of the PET bottles.

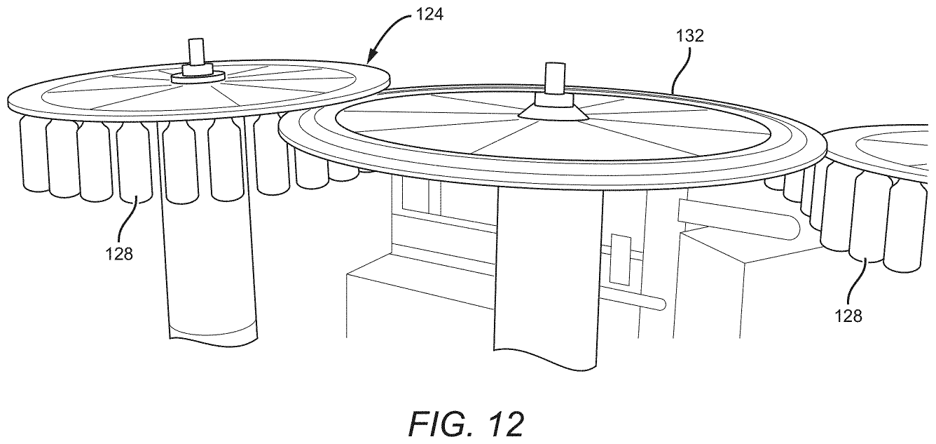

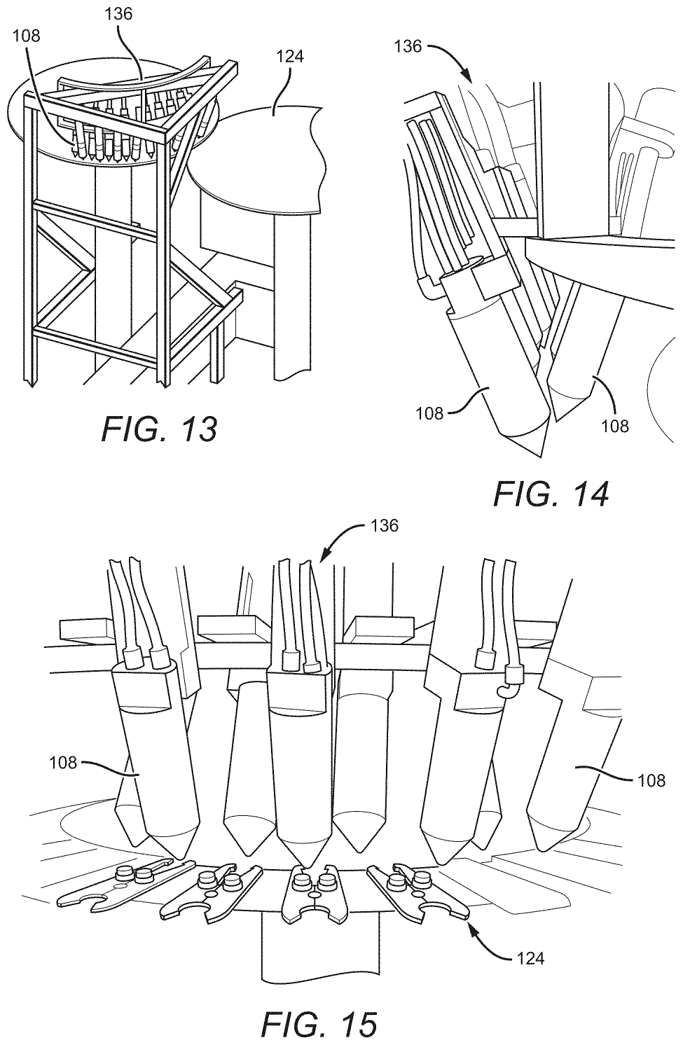

FIG. 12 illustrates an exemplary embodiment of a conveyor system 124 transporting a multiplicity of PET bottles 128 to a bottle labeler 132, indicating an advantageous location for installation of plasma treatment nozzles 108. An exemplary embodiment of a plasma treatment apparatus 136 for reducing scratches on PET bottles 128 is shown in FIG. 13. The plasma treatment apparatus 136 comprises a multiplicity of plasma nozzles 108, or jets, disposed above the conveyor system 124. During operation of the conveyor system 124, therefore, the plasma treatment 100 is applied to the PET bottles 128 as they are moved along the bottle filling line toward the bottle labeler 132, as shown in FIG. 17.

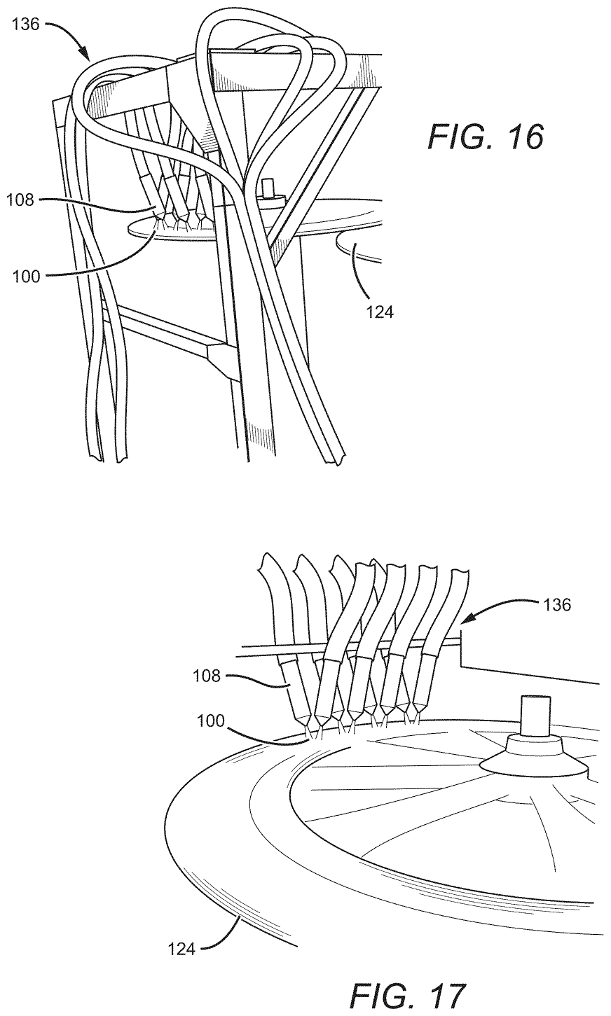

In the illustrated embodiment of FIGS. 14-15, the plasma treatment apparatus 136 includes eight plasma nozzles 108 arranged in a “staggered” configuration so as to distribute the plasma treatment 100 to all parts of the neck finish approximately evenly. In some embodiments, however, the plasma treatment apparatus 136 may include more than eight plasma nozzles 108, arranged in various configurations, as found to be beneficial. For example, in one embodiment, the plasma treatment apparatus 136 includes eight plasma nozzles 108 arranged in a straight configuration, such that the plasma nozzles 108 point at opposite sides of the bottle neck finishes. In some embodiments, the plasma treatment apparatus 136 includes more than eight plasma nozzles 108, such as sixteen nozzles 108, whereby a relatively greater plasma treatment is applied to the bottle neck finishes. It is contemplated that, in some embodiments, the plasma treatment apparatus 136 may be disposed in a suitable location within the bottle labeler 132, as shown in FIG. 16, without limitation.

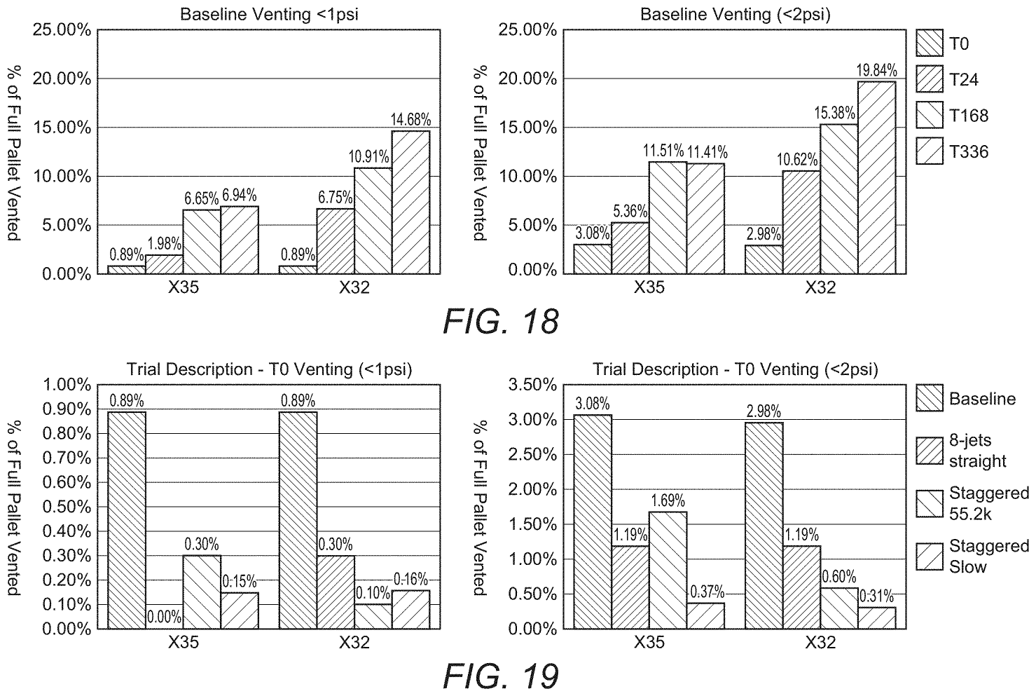

FIGS. 18-23 are graphs illustrating baseline bottle venting and reductions of bottle venting per pallet, relative to baseline, after having been plasma treated in accordance with the present disclosure. In particular, FIG. 18 illustrates graphs of baseline venting as a percentage of full pallet vented occurring over time expressed in hours. As will be appreciated, the percentage of full pallet vented generally increases over time. FIGS. 19-23 illustrate graphs of bottle venting occurring over time, expressed in hours, after having received the plasma treatment 100, as described hereinabove.

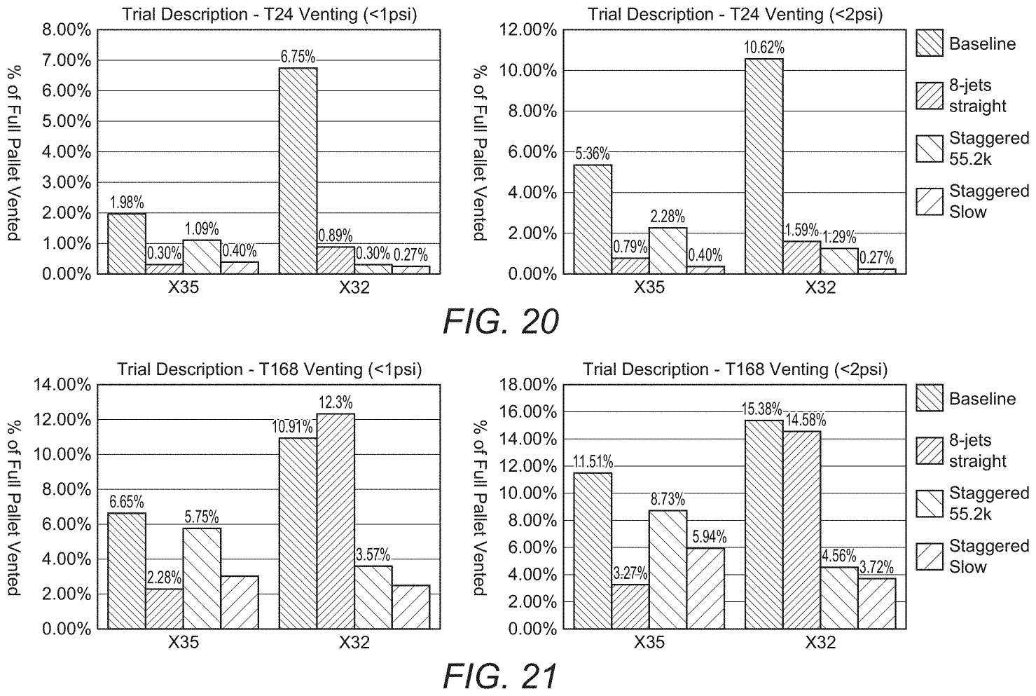

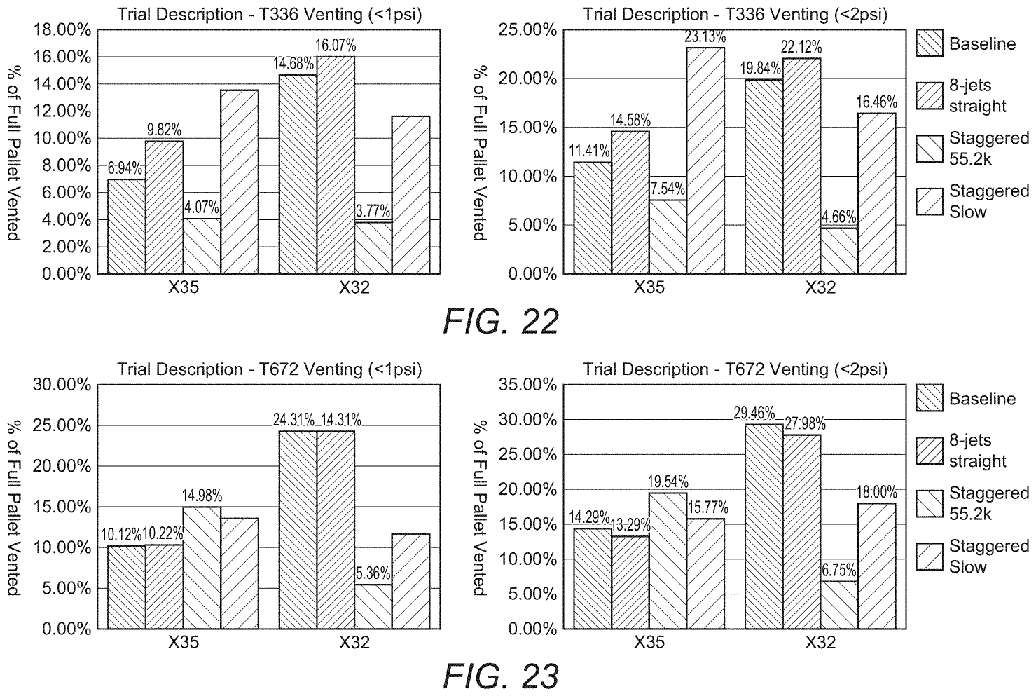

In particular, FIG. 19 illustrates graphs of percentage of full pallet vented at T=0 hours after receiving the plasma treatment 100. The plasma treatment 100 was performed with 8 plasma nozzles 108 that were in a staggered configuration as well as with the plasma nozzles 108 disposed in a straight configuration. The staggered configuration was performed with the PET bottles 128 being conveyed at a first speed and at a second speed being half the first speed. It is contemplated that the second speed of the PET bottles 128 simulates a system comprising 16 plasma nozzles 108 in the staggered configuration. In the straight configuration, 4 plasma nozzles 108 were disposed on each side of the PET bottles 128. FIG. 20 illustrates graphs of percentages of full pallet vented at T=24 hours after receiving the plasma treatment 100. Graphs of percentages of full pallet vented at T=168 hours after receiving the plasma treatment 100 are illustrated in FIG. 21. FIG. 22 illustrates graphs of percentages of full pallet vented at T=336 hours after receiving the plasma treatment 100. FIG. 23 illustrates graphs of percentages of full pallet vented at T=672 hours after receiving the plasma treatment 100. As will be appreciated, plasma treatment generally gives rise to a reduction in bottle venting relative to baseline. In some embodiments, the plasma treatment 100 gives rise to venting reduction as high as 96%, up to 24 hours after production was observed. Further, in some embodiments, testing of the plasma treatment 100 shows a representative 41% reduction in venting relative to baseline, up to 4 weeks after production.

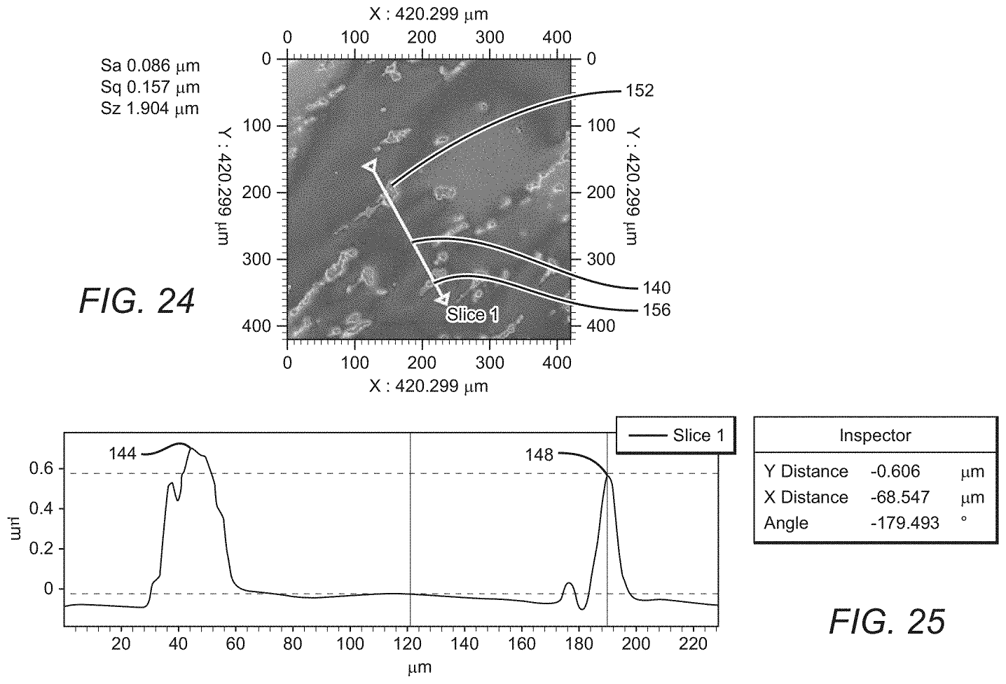

FIG. 24 illustrates a surface scan showing a surface roughening observed on a polymer after the plasma treatment 100, according to the present disclosure. A scan line 140 indicates a path of the surface scan over the surface, labeled “Slice 1.” FIG. 25 is a graph illustrating surface heights detected along a scan line 140. The graph displays a first peak 144 and a second peak 148 that respectively correspond to raised portions 152, 156 disposed on the surface shown in FIG. 24. In general, it has been observed that the surface roughening is peculiar to the plasma and thus provides a signature of a surface that has received the plasma treatment 100. It is contemplated, therefore, that since this surface roughening is characteristic and robust, the presence of this surface roughening can be used to identify whether or not a product has been treated with the plasma treatment 100, as described hereinabove.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A plasma treatment system for repairing scratches applied to PET bottles, preforms and closures, the system comprising:
one or more plasma nozzles disposed along a bottle filling line;
a plasma being issued by way of the one or more plasma nozzles, the plasma being suitable for repairing scratches in PET bottles; and
a multiplicity of PET bottles being processed by way of the bottle filling line.

2. The system of claim 1, wherein the one or more plasma nozzles include any of single nozzles, one or more stationary nozzles, and rotary nozzles.

3. The system of claim 2, wherein the one or more plasma nozzles are positioned between 1 mm and 10 mm above the PET bottles.

4. The system of claim 3, wherein the one or more plasma nozzles are positioned between 4 mm and 7 mm above the PET bottles.

5. The system of claim 1, wherein the one or more plasma nozzles are positioned to treat the inside of a neck finish comprising each of the multiplicity of PET bottles where a plug seal comprising the closure establishes a seal.

6. The system of claim 5, wherein the outside and top of each of the multiplicity of PET bottles are plasma treated due to the motion of the multiplicity of PET bottles along the bottle filling line and relative to the one or more plasma nozzles.

7. The system of claim 1, wherein the one or more plasma nozzles are configured to treat the multiplicity of PET bottles before closures are coupled with the multiplicity of PET bottles.

8. The system of claim 7, wherein the multiplicity of PET bottles are treated after all machine handling has finished at one or more sealing locations.

9. The system of claim 1, wherein plasma treatment of the multiplicity of PET bottles is performed in a bottle labeler, after blowing the multiplicity of PET bottles and before filling the multiplicity of PET bottles.

10. The system of claim 1, wherein plasma treatment of the multiplicity of PET bottles is performed after filling the multiplicity of PET bottles so as to avoid potential scratches to any of the multiplicity of PET bottles due to misaligned filling tubes.

11. The system of claim 1, wherein the one or more plasma nozzles includes a number of plasma nozzles arranged into a configuration that distributes plasma to all parts of a neck finish comprising each of the multiplicity of PET bottles.

12. The system of claim 1, wherein the one or more plasma nozzles includes between 4 plasma nozzles and 16 plasma nozzles that are arranged into a staggered configuration, a straight configuration, or a combination thereof.

13. The system of claim 12, wherein the one or more plasma nozzles includes 8 plasma nozzles arranged in a staggered configuration to distribute plasma to all parts of a neck finish comprising each of the multiplicity of PET bottles.

14. The system of claim 12, wherein the one or more plasma nozzles includes 8 plasma nozzles arranged in a straight configuration, such that the plasma nozzles point at opposite sides of a neck finish comprising each of the multiplicity of PET bottles.

15. A method for a plasma treatment system for repairing scratches applied to PET bottles, preforms and closures, the method comprising:
disposing one or more plasma nozzles along a bottle filling line;
configuring the one or more plasma nozzles to discharge a plasma suitable for repairing scratches in PET bottles; and
subjecting a multiplicity of PET bottles to the plasma during processing by way of the bottle filling line.

16. The method of claim 16, wherein disposing includes positioning the one or more plasma nozzles to treat the inside of a neck finish comprising each of the multiplicity of PET bottles, wherein the inside of the neck finish comprises a location where a plug seal of a bottle closure establishes a seal.

17. The method of claim 16, wherein disposing includes positioning the one or more plasma nozzles in a bottle labeler comprising the bottle filling line.

18. The method of claim 16, wherein disposing includes positioning the one or more plasma nozzles at a location of the bottle filling line after filling of the multiplicity of PET bottles so as to avoid potential scratches to any of the multiplicity of PET bottles due to misaligned filling tubes.

19. The method of claim 16, wherein disposing includes arranging the one or more plasma nozzles into a configuration that uniformly distributes plasma to all parts of a neck finish comprising each of the multiplicity of PET bottles.

20. A plasma treatment system for repairing defects in polymer closures, the system comprising:
one or more plasma nozzles disposed along a bottle filling line;
a multiplicity of polymer closures being processed by way of a conveyor or a rail of the bottle filling line; and
a plasma being issued by way of the one or more plasma nozzles, the plasma being suitable for repairing defects in the multiplicity of polymer closures.

21. The system of claim 20, wherein the defects include gas marks and scratches disposed in any of the multiplicity of polymer closures.
